(19) United States
(12) Patent Application Publication
(10) Pub. No.: US 2026/0105089 A1
(43) Pub. Date: Apr. 16, 2026

(54) SYSTEMS AND METHODS FOR EMBEDDING FOR TEXT AND CODE RETRIEVAL

(71) Applicant: Salesforce, Inc., San Francisco, CA (US)

(72) Inventors: Ye Liu, Fremont, CA (US); Rui Meng, San Francisco, CA (US); Semih Yavuz, Redwood City, CA (US); Yingbo Zhou, Palo Alto, CA (US); Caiming Xiong, Menlo Park, CA (US)

(21) Appl. No.: 19/222,722

(22) Filed: May 29, 2025

Related U.S. Application Data
(60) Provisional application No. 63/707,618, filed on Oct. 15, 2024.

(51) Int. Cl. G06F 16/334; G06N 3/08

(52) U.S. Cl. CPC G06F 16/334; G06N 3/08

(57) ABSTRACT

Embodiments described herein provide a method for a unified code and natural language search system that integrates both natural language and programming language queries and documents. The method includes receiving a training dataset comprising natural language and programming language queries and documents, and training a neural network-based embedding model in two stages: first, by adapting the model with natural language query-document pairs, and then further adapting it with combined programming and natural language query-document pairs. The updated parameters from each stage are integrated into the model to enhance retrieval capabilities. In response to a search query, the trained embedding model retrieves relevant documents from a collection based on the similarity between the query and document embeddings.

### CROSS REFERENCE(S)

The instant application is a nonprovisional of and claim priority under 35 U.S.C. 119 to U.S. provisional application No. 63/707,618, filed Oct. 15, 2024, which is hereby expressly incorporated by reference herein in its entirety.

### TECHNICAL FIELD

The embodiments relate generally to machine learning systems for generative AI, and more specifically to systems and methods for embedding for text and code retrieval.

### BACKGROUND

AI agents, commonly known as AI agents or virtual assistants, can be applied to a wide range of practical applications across various industries. In customer service, AI agents can handle user inquiries, provide support, and resolve issues 24/7, improving customer satisfaction and reducing operational costs. In healthcare, AI agents can offer initial consultations, answer health-related questions, and remind patients to take their medications. In the e-commerce sector, AI agents can assist with product recommendations, order tracking, and personalized shopping experiences. In information technology (IT) support, these agents can guide users through troubleshooting steps, helping them resolve software and hardware issues. Specifically, for network hazards, AI agents can diagnose connectivity problems, suggest corrective actions, and provide step-by-step guidance to ensure network security and stability. Their versatility and ability to handle diverse tasks make them valuable tools in enhancing efficiency and user experience in various fields.

AI agents often employ a neural network based generative language model to generate an output such as in the form of a text response, or a series actions to complete a complex task, such as to network issue troubleshooting, etc. Such generative language model receives a natural language input in the form of a sequence of tokens, and in turn generates a predicted distribution over a token space conditioned on the input sequence. Generated output tokens over time may in turn form the text response, or actions for completing the task.

To improve the performance and accuracy of AI agents, relevant information may be retrieved based on a given query, and the retrieved information may be added to the context for the LLM for generating a response. Existing retrievers are generally designed on a unilingual basis, e.g., to retrieve context information and/or documents in natural language based on a natural language query or description. Such unilingual context retrieval often fails to address the structural and semantic complexities of retrieving context information in programming languages. Further, the number of different programming languages further complicates understanding and/or retrieval of code as context information for LLM generation.

### BRIEF DESCRIPTION OF THE DRAWINGS

FIG. 1 illustrates an example operation of an LLM based AI agent, according to some embodiments.

FIG. 2 illustrates a simplified diagram of a retrieval augmented generation framework, according to some embodiments.

FIG. 3 illustrates an embedding model training framework, according to some embodiments.

FIG. 4A is a simplified diagram illustrating a computing device implementing the generative AI framework described in FIGS. 1-3, according to some embodiments.

FIG. 4B is a simplified diagram illustrating a neural network structure, according to some embodiments.

FIG. 5 is a simplified block diagram of a networked system suitable for implementing the generative AI framework described in FIGS. 1-4B and other embodiments described herein.

FIG. 6 is an example logic flow diagram illustrating a method of unified code and natural language search based on the framework shown in FIGS. 1-5, according to some embodiments.

FIGS. 7-13 provide charts illustrating exemplary performance of different embodiments described herein.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

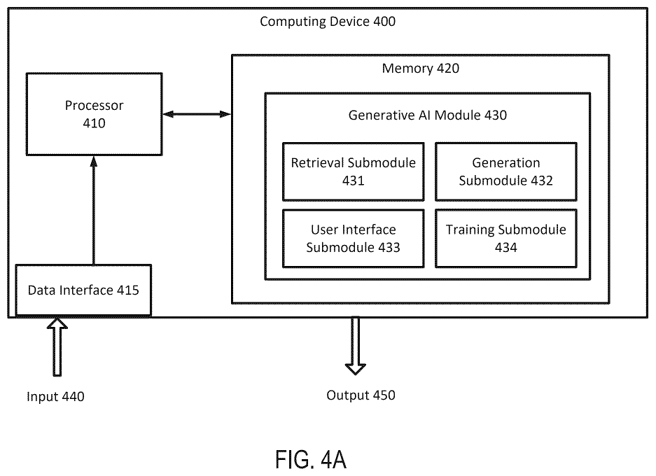

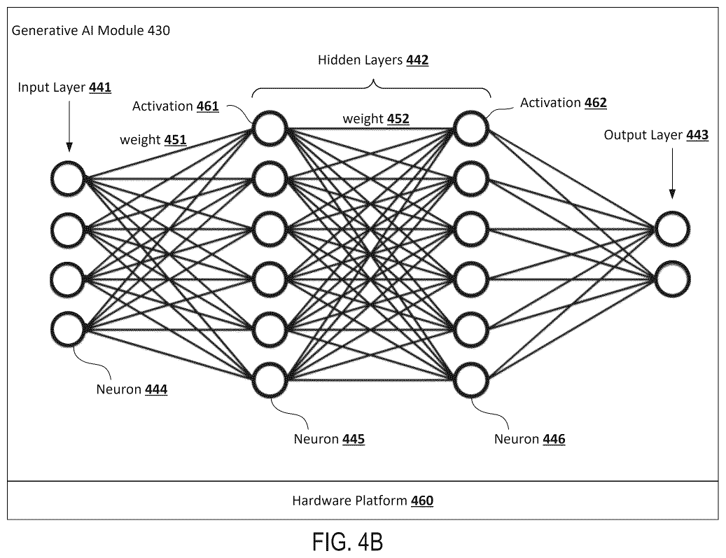

As used herein, the term “Transformer” may refer to an architecture of a deep learning model designed to process sequential data, such as text, using a mechanism called self-attention. The Transformer architecture handles an entire input sequence of tokens (such as words, letters, symbols, etc.) in parallel, and often generate an output sequence of tokens sequentially. The Transformer architecture may comprise a stack of Transformer layers, each of which contains a self-attention module to weigh the importance of each token relative to other tokens in the sequence and a feed-forward module to further transform the data. Additional details of how a Transformer neural network model processes input data to generate an output is provided in relation to FIG. 4B.

As used herein, the term “Large Language Model” (LLM) may refer to a neural network based deep learning system designed to understand and generate human languages. An LLM may adopt a Transformer architecture that often entails a significant amount of parameters (neural network weights) and computational complexity. For example, LLM such as Generative Pre-trained Transformer (GPT) 3 has 175 billion parameters, Text-to-Text Transfer Transformers (T5) has around 11 billion parameters. An LLM may comprise an architecture of mixed software and/or hardware, e.g., including an application-specific integrated circuit (ASIC) such as a Tensor Processing Unit (TPU).

As used herein, the term “generative artificial intelligence (AI)” may refer to an AI system that outputs new content that does not pr-exist in the input to such AI system. The new content may include text, images, music, or code. An LLM is an example generative AI model that generate tokens representing new words, sentences, paragraphs, passages, and/or the like that do not pre-exist in an input of tokens to such LLM. For example, when an LLM generate a text answer to an input question, the text answer contains words and/or sentences that are literally different from those in the input question, and/or carry different semantic meaning from the input question.

As used herein, the term “AI agent” may refer to a set of software and/or hardware that processes information from its environment and takes action to achieve specific goals such as executing a task. For example, an AI agent (like a chatbot or virtual assistant) might use an LLM as a component but also integrate tools like web browsing, APIs, databases, and other forms of reasoning to complete tasks.

### Overview

To improve the performance and accuracy of AI agents, relevant information may be retrieved based on a given query, and the retrieved information may be added to the context for the LLM for generating a response. Existing retrievers are generally designed for natural language queries and often fail to address the structural and semantic complexities of retrieving code. Further, the number of different programming languages further complicates understanding and/or retrieval of code.

Embodiments described herein provide a framework for generative AI including training and utilizing neural network-based embedding models that are capable of representing both natural language and programming language content within a single system. These embodiments address the challenge of retrieving relevant information across heterogeneous data types such as natural language documents and code repositories by enabling a single embedding model to encode queries and documents from both domains into a shared semantic space. This unified approach allows for more effective and accurate retrieval of information, regardless of whether the query or the target document is expressed in natural language, code, or a combination of both.

Embodiments herein provide a retrieval system that is trained via a two-stage training pipeline to retrieve an item across different programming languages or a combination of programming and natural languages, in response to a code, text or combined query. Specifically, the retrieval system comprises an embedding model (e.g., an LLM) to embed queries and documents (either code, text or hybrid), with retrieval being based on proximity of the query to the document in the embedded space.

In some embodiments, each of the training stages utilize a distinct low rank adaptation (LoRA) adapter (e.g., trainable low-rank matrices to be injected into specific layers of the original embedding model), trained using natural language query-document pairs or combined natural language and code query-document pairs, respectively. Updated LoRA parameters after the first stage may be integrated into the embedding model before the second stage. After the two-stage training, the embedding model may be used to embed any natural language or code query or documents, such that Text-to-Text, Text-to-Code, Code-to-Text, and Code-to-Code retrieval may be handled within a single retrieval system.

The training process may further be optimized by employing learning rate schedules tailored to each training stage, and by leveraging large batch sizes through memory-efficient techniques to improve contrastive learning. As a result, these embodiments enable a versatile, scalable, and high-performing system for unified retrieval and generation across natural language and programming language content.

Once trained, the embedding model can be deployed in a retrieval-augmented generation (RAG) system. In such a system, a user may submit a search query (expressed in natural language, code, or both) and the system retrieves the most relevant documents or code snippets from a corpus by comparing the similarity of their embeddings. The retrieved content can then be incorporated into downstream applications, such as code completion, code summarization, or natural language content generation, by providing the retrieved context to a language model that generates a final output. This approach not only improves the relevance and accuracy of generated responses but also enables advanced features such as code auto-completion, hybrid search, and context-aware content generation across both code and text domains.

In one embodiment, the retrieval system may be used to build an AI coding agent implemented at an integrated coding environment (IDE) to incorporate retrieved code segments directly into a code file being edited at the IDE, auto-complete partial lines of code based on retrieved results, and support for a variety of query-document pairings (e.g., natural language to code, code to natural language, code to code, and natural language to natural language).

Embodiments herein provide a number of benefits. For example, by unifying the retrieval of both natural language and programming language content within a single neural network-based embedding model, these embodiments enable more efficient and accurate information retrieval across heterogeneous data types, reducing the need for separate specialized systems and thereby minimizing the memory and computation needs of the system. In another example, the multi-stage training process where the model is first trained on natural language data and then incrementally adapted to code and hybrid data using modular LoRA adapters prevents catastrophic forgetting and ensures that the model retains strong performance in both text and code retrieval tasks. In another example, the ability to retrieve and incorporate relevant code segments or documentation directly into coding environments or downstream language models enables advanced features such as code auto-completion, hybrid search, and context-aware content generation, which directly improve developer productivity and the reliability of code generation systems. In another example, the unified framework supports a wide range of query-document pairings, allowing for seamless integration into various software development and information retrieval applications. Therefore, neural network technology in cross-domain information retrieval and code-centric applications is improved.

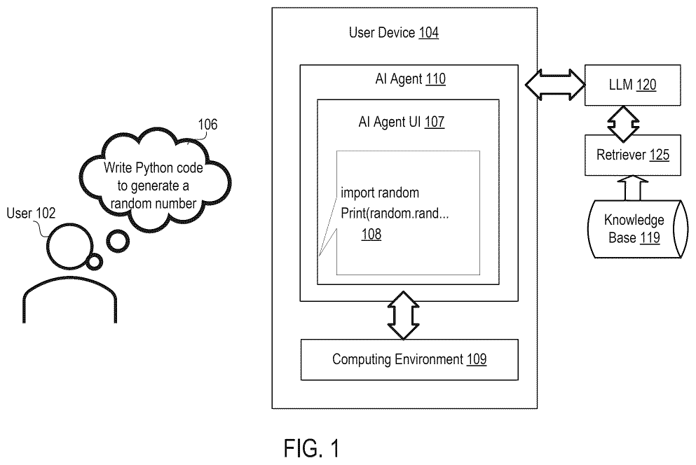

FIG. 1 shows an example operation of an LLM based AI agent, according to embodiments of the present disclosure. An LLM-based AI agent 110 may be implemented on a user device 104 to receive a user task request 106 as a natural language input, typically through a chat or command interface 107. This request 106 may range from simple queries to more complex tasks like data analysis, automation, or even generating content. For example, the user 102 may ask the AI agent to “write Python code to generate a random number” 106.

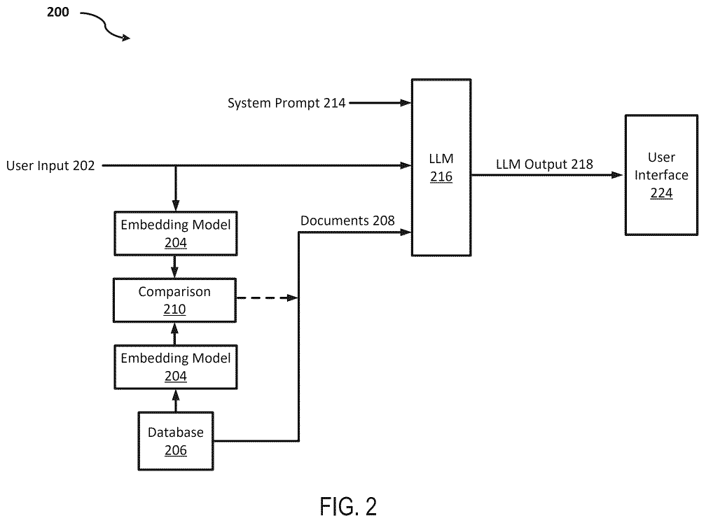

In one embodiment, the AI agent 110 may processes the task request 106 at an LLM 120 to understand its intent, extracting key information such as the task type, desired outcome, and any specific constraints in order to generate a response. The LLM 120 may be hosted at an external server, a cloud service, and/or the like that is accessible by a communication network. In a different implementation, the LLM 120 may be hosted on the user device 104. An input to the LLM 120 may comprise the task request 106 and instruction provided to the LLM 120 to guide its behavior or responses in a particular way, referred to as a “system prompt.” For example, the system prompt may contain instruction for the LLM 120 to analyze the input and respond according to the request identified in the input, and generate an output in a certain format, e.g., suggested code program, text description, etc. The LLM 120 may in turn generate a response 108 based on an input combining the task request 106 and any system prompt. The LLM 120 may operate with a retriever model 125, which retrieves relevant context documents from a knowledge base 119 as a context, to in turn generate a textual response 108 based on an input combining the task request 106, any system prompt and the retrieved context. Additional details on the LLM 120 generating output tokens to form the response 108 may be described in FIG. 2.

The response 108 may include instructions, explanations, code scripts or direct actions to address the task request 106. Such response 108 may be displayed via the AI agent interface 107 for transparency. In addition to the response 108 that describes how to fulfill the task request, the LLM 120 may generate computer-executable commands (e.g., system-level commands, Python scripts, etc.) that can directly trigger actions and/or interactions with the computing environment 109 on the user device 104.

For example, when the user 102 requests to generate code, the LLM 120 may output a code script to execute on the computing environment 109 on the user device 104 to perform the requested action, and/or interface with APIs of other applications to perform the requested action.

In this way, the LLM-based AI agent 110 may facilitate end-to-end workflow to automate the task request 106. Embodiments described herein including the training of an embedding model and improved retrieval may be utilized to improve the performance of the LLM-based AI agent 110, as further described in FIGS. 2-13 below.

FIG. 2 illustrates a simplified diagram of a retrieval augmented generation framework 200, according to some embodiments. Framework 200 brings together several key components to enable the generation of contextually informed responses to user queries by integrating retrieval and generative processes. The process begins with user input 202, which represents a query or request submitted by the user. This may be in the form of a direct request (e.g., “write python code to . . . ”) or may be in the form of a partial line of code and the system is configured to suggest an auto-completion of the code, and/or the like. This user input 202 is provided to embedding model 204, which is tasked with embedding the user input 202 to a vector representation.

In some embodiments, embedding model 204 may utilize a bidirectional large language model (LLM) as the embedding model. A bidirectional LLM processes the input sequence by considering both the preceding and succeeding context for each token, enabling the generation of richer semantic representations. To generate a semantic vector representation from the bidirectional LLM, various pooling strategies may be employed. For example, last token pooling involves extracting the hidden state corresponding to the last token in the input sequence as the embedding vector. Alternatively, beginning token pooling may be used, where the hidden state of the first token (often a special classification token such as [CLS]) is selected as the semantic vector representation. These pooling methods allow the system to capture the overall meaning of the input sequence in a fixed-size vector suitable for downstream retrieval tasks.

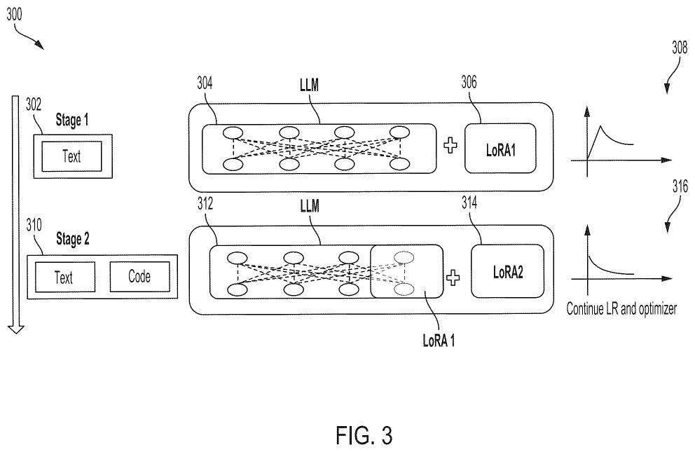

Embedding model 204 may be trained as described herein (e.g., with respect to FIG. 3). The same embedding model 204 may be used for embedding user input 202 and documents in database 206. In some embodiments, embedding of the user input 202 is performed via a different embedding model than the documents in database 206. Documents in database 206 may include articles, records, code, user-AI interactions (e.g., with a code agent), descriptions of code issue fixes, code translation examples, or other data sources that could potentially contain information relevant to the user's query. In some embodiments, database 206 includes the ability to search the internet for documents, where the search query may be based on user input 202. Internet documents may be retrieved and catalogued prior to receiving user input 202, or may be searched for in real-time in response to user input 202.

Documents 208 may be selected based on a comparison 210 of embeddings of user input 202 and documents in database 206. For example, the k nearest embeddings of documents in database 206 to the embedding of user input 202 may be selected for retrieval, where k may be a preconfigured number. In some embodiments, documents 208 are ranked, and the ranking is indicated to LLM 216.

The retrieved documents 208, together with the original user input 202, are then combined with system prompt 214. System prompt 214 provides additional instructions or context to guide the behavior of large language model (LLM) 216. LLM 216 receives this combined input and processes it to generate a response, LLM output 218. LLM output 218 constitutes the system's answer or completion, informed by both the retrieved content and the generative capabilities of the LLM.

LLM output 218 is then presented to the user via user interface 224. User interface 224 acts as the communication bridge between the user and the system, displaying the generated response and enabling further interaction if desired. Through this coordinated flow, framework 200 demonstrates how user queries are transformed into informed, context-aware responses by leveraging both retrieval from a large database and advanced language generation. The overall accuracy of LLM outputs 218 are highly connected to the relevance of the retrieved documents. The relevance of the retrieved documents may be improved via an improvement to embedding model 204. Specifically, in the case of mixed natural language and code environments, embedding model 204 may be trained to provide highly relevant documents 208 as described further in FIG. 3 below.

FIG. 3 illustrates an embedding model training framework 300, according to some embodiments. Framework 300 is designed to enable unified retrieval of both natural language and programming language content by leveraging a multi-stage training process that incrementally adapts a large language model (LLM) to diverse retrieval tasks. Specifically, the LLM is trained for use as an embedding model. In the first stage, stage 1 training data 302, which comprises natural language text, is used to train LLM 304. During this stage, LoRA 306, a low-rank adaptation module, is applied to LLM 304 to introduce trainable parameters that specialize the model for text-based retrieval tasks. The learning rate 308 is dynamically adjusted throughout stage 1, typically starting with an increasing schedule followed by an exponential decay, to optimize the training process and ensure stable convergence of the LoRA 306 parameters. As a result, LLM 304, modified by LoRA 306, learns to generate high-quality embeddings for natural language queries and documents. In some embodiments, during stage 1 training, input queries are natural language prompts, and the known-good documents for retrieval are natural language documents. Training of LoRA 306 parameters may include updating parameters of LORA 306 so that the embeddings of a prompt and an associated response are closer together in embedding space (e.g., cosine similarity of vector embeddings). In some embodiments, contrastive learning may be performed in which negative samples are pushed away in embedding space via updating of the parameters of LoRA 306.

Upon completion of stage 1, the trained parameters of LORA 306 may be merged into LLM 304, resulting in LLM 312, which now incorporates the knowledge acquired during the initial text retrieval training. In stage 2, stage 2 training data 310, which includes both natural language text and code, is used to further adapt LLM 312. At this point, a new LoRA 314 is introduced and trained specifically on the combined set of natural language and programming language query-document pairs. The learning rate 316 for stage 2 may be initialized to the final value used in stage 1 and then decays exponentially, ensuring a smooth transition and preventing abrupt parameter shifts that could destabilize the model. During this stage, only the parameters of LORA 314 are updated, while the previously learned parameters from LoRA 306 remain fixed within LLM 312, thereby preserving the model's strong performance on text retrieval while enhancing its capabilities for code retrieval and hybrid tasks. LoRA 314 may be integrated into LLM 312. The final integrated LLM may be used as embedding model 204, for example for code generation tasks as described in FIG. 2.

Throughout both stages, the framework 300 formulates all retrieval tasks as query-document matching problems, where each query and document is encoded by the LLM (either 304 or 312, depending on the stage) into dense embeddings. The similarity between query and document embeddings is computed, for example, using cosine similarity, to facilitate efficient and accurate retrieval. This approach allows framework 300 to support a wide range of retrieval scenarios, including text-to-text, text-to-code, code-to-text, and code-to-code, as described in the claims. The modular use of LORA adapters (306 and 314) at each stage enables the model to iteratively adapt to new retrieval objectives without catastrophic forgetting, and the staged learning rate schedules (308 and 316) ensure stable and effective optimization across both training phases.

By structuring the training process in this manner, framework 300 achieves robust and generalizable retrieval performance across heterogeneous data types. The multi-stage approach enables the embedding model to iteratively improve retrieval performance while preventing overfitting to any single modality. The result is a unified embedding model that can retrieve documents from a plurality of sources based on similarity comparisons of query and document embeddings. This comprehensive design, as depicted in FIG. 3, enables seamless integration into downstream applications such as code search, documentation retrieval, and retrieval-augmented generation, and provides the technical foundation for the unified code and natural language search system described in the specification.

Training of an embedding model (e.g., embedding model 204) may be formally described as follow. A structured retrieval pair may be represented as (Q, D), where Q is the query and D is the positive document. The retrieval process may be formulated as a ranking problem, where the objective is to learn a function ƒ(Q, D) that assigns higher similarity scores to relevant pairs than that of irrelevant ones.

To train a unified retrieval model (e.g., embedding model 204) for both code and text, retrieval tasks of various types may be transformed into a query-document matching problem, where a query Q retrieves a relevant document D from a candidate set D. This allows Text-to-Text, Text-to-Code, Code-to-Text, and Code-to-Code retrieval to be handled within a single framework.

Each query Q and document D are encoded using a pre-trained large language model (LLM), with bidirectional attention to enhance contextual dependencies for embedding-based retrieval tasks:

$$q = {LLM}_{θ + Δθ} ( Q ) , d = {LLM}_{θ + Δθ} ( D ) , \qquad ( 1 )$$

By applying bidirectional attention to the causal LLM, the model effectively encodes semantic relationships across full input sequences, making it more suitable for retrieval applications. The resulting retrieval task in the inference is then formulated as:

$${D}^{*} = arg {max}_{D ∈ D} sim ( q , d ) \qquad ( 2 )$$

where the similarity function is defined as:

$$sim ( q , d ) = \frac{q \cdot d}{‖ q ‖ ‖ d ‖} \qquad ( 3 )$$

To progressively enhance retrieval capabilities, a multi-stage training approach may be utilized, with distinct LoRA adapters at each stage. A LoRA (Low-Rank Adaptation) adapter is a lightweight, trainable module that is inserted into specific layers (e.g., the attention and/or feed-forward layers) of a pre-trained large language model (LLM) to enable efficient fine-tuning for specific tasks. In some embodiments, LoRA works by introducing additional low-rank matrices into the weight update path of selected layers (such as the query, key, or value projection matrices in the attention mechanism). During training, the input to a LoRA-adapted layer is processed by the frozen original weights of the LLM, and also a learned low-rank update (the LoRA adapter) is applied to the same input. The outputs of the LoRA module are then added to the outputs of the original layer, resulting in a combined representation that incorporates both the pre-trained knowledge and the task-specific adaptation. The combination may be a weighted sum, which in some embodiments may weight the frozen model output more than the LoRA output. Instead of updating all the parameters of the large model, which can be computationally expensive and require significant memory, LoRA adapters introduce a small number of additional parameters that are trained while keeping the original model weights frozen. This approach significantly reduces the computational cost and memory requirements compared to full model fine-tuning, making it practical to adapt large models to new tasks or domains. In each stage, the previously trained LoRA weights may be merged into the base model before initializing a new adapter. This approach enables the model to iteratively adapt to different retrieval objectives without catastrophic forgetting.

In stage 1, supervised contrastive pretraining is performed on text data. A LoRA adapter Δθ₁ (e.g., LoRA 306) is initialized and parameters of the LLM θ (e.g., LLM 304) are kept frozen, while training Δθ₁ on text-based retrieval tasks using a contrastive learning objective:

$$ℒ = - \frac{1}{N} {\sum }_{i = 1}^{N} log \frac{exp ( sim ( {q}_{i} , {d}_{i}^{+} ) )}{exp ( sim ( {q}_{i} {d}_{i}^{+} ) ) + \sum \frac{K}{j = 1} exp ( sim ( {q}_{i} , {d}_{j}^{-} ) )} \qquad ( 4 )$$

where

$${d}_{i}^{+}$$

is a positive document, and

$${d}_{j}^{-}$$

represents negative documents, and N denotes the batch size. The model learns to align text queries with their corresponding text-based documents, establishing a strong foundation for language-based retrieval.

After training, the trained adapter Δθ₁ may be merged into the base LLM model:

$$θ ← θ + Δ {θ}_{1} \qquad ( 5 )$$

and a new LoRA adapter Δθ₂ (e.g., LoRA 314) may be initialized to learn retrieval for both code and text. This setup enables the model to mitigate text-only biases while preserving most of its learned representations.

To ensure a smooth transition between training phases, optimizing the second-stage LoRA adapter Δθ₂ may continue the gradient contributions from the first-stage adapter Δθ₁, remain fixed within the model. Specifically, Δθ₂ may be updated while preserving the learning rate r⁽¹⁾ and the accumulated gradient from Δθ₂:

$$Δ {θ}_{2} ← Update ( {Δθ}_{2} , ∇ L ( {θ}_{1} , {θ}_{2} ) , {r}^{( 1 )} ) \qquad ( 6 )$$

where ∇L(θ₁, θ₂) represents the gradient influenced by both adapters, but only Δθ₂ is actively updated. This approach stabilizes optimization, preventing abrupt parameter shifts while allowing a smooth adaptation to code retrieval. By preserving the previous learning rate and gradient continuity, convergence instability is mitigated and efficient adaptation is facilitated.

Multiple code generation and classification tasks may be transformed into the (Q, D) format for code retrieval training. For example, tasks such as code contest generation take problem descriptions and map them to the correct implementation, and data of this type may map descriptions to query Q and the solution as the document D. Similarly, in Text-to-SQL, a user query in natural language serves as Q and the corresponding SQL query is treated as D. Code-to-text retrieval retrieves human-readable descriptions (mapped to D) for given code snippets (mapped to Q). In code summarization, a code snippet serves as Q, and the corresponding documentation or summary is D. Code-to-code retrieval represents retrieving functionally equivalent or semantically related code snippets, in which case the pairs of code may be respectively mapped to Q and D. In code translation, the source code in one language is mapped to Q, and its equivalent implementation in another language is mapped to D. In Code completion, an incomplete code fragment may be mapped as Q and the correct completion as D. Code clone detection retrieves functionally similar code, allowing the reference snippet to be mapped as Q and the detected duplicate as D. In code agent conversation, user prompts containing explanations or code snippets act as Q, while the retrieved response (either code or text) serves as D. In code issue fixing, a hybrid query consists of an error message and buggy code which may be mapped as Q, while the corrected version of the code is mapped as D.

In this way various training data types for different applications may be mapped to the retrieval scenario for training a retrieval model (e.g., embedding model 204). By consolidating diverse retrieval tasks into a unified framework, seamless adaptation across a wide range of programming scenarios is facilitated while ensuring high retrieval accuracy.

### Computer and Network Environment

FIG. 4A is a simplified diagram illustrating a computing device implementing the generative AI framework described in FIGS. 1-3, according to one embodiment described herein. As shown in FIG. 4A, computing device 400 includes a processor 410 coupled to memory 420. Operation of computing device 400 is controlled by processor 410. And although computing device 400 is shown with only one processor 410, it is understood that processor 410 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 400. Computing device 400 may be implemented as a stand-alone subsystem, as a board added to a computing device, and/or as a virtual machine.

Memory 420 may be used to store software executed by computing device 400 and/or one or more data structures used during operation of computing device 400. Memory 420 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 410 and/or memory 420 may be arranged in any suitable physical arrangement. In some embodiments, processor 410 and/or memory 420 may be implemented on a same board, in a same package (e.g., system-in-package), on a same chip (e.g., system-on-chip), and/or the like. In some embodiments, processor 410 and/or memory 420 may include distributed, virtualized, and/or containerized computing resources. Consistent with such embodiments, processor 410 and/or memory 420 may be located in one or more data centers and/or cloud computing facilities.

In another embodiment, processor 410 may comprise multiple microprocessors and/or memory 420 may comprise multiple registers and/or other memory elements such that processor 410 and/or memory 420 may be arranged in the form of a hardware-based neural network, as further described in FIG. 4B.

In some examples, memory 420 may include non-transitory, tangible, machine readable media that includes executable code that when run by one or more processors (e.g., processor 410) may cause the one or more processors to perform the methods described in further detail herein. For example, as shown, memory 420 includes instructions for generative AI module 430 that may be used to implement and/or emulate the systems and models, and/or to implement any of the methods described further herein. generative AI module 430 may receive input 440 such as an input training data (e.g., queries) via the data interface 415 and generate an output 450 which may be code or natural language text.

The data interface 415 may comprise a communication interface, a user interface (such as a voice input interface, a graphical user interface, and/or the like). For example, the computing device 400 may receive the input 440 (such as a training dataset) from a networked database via a communication interface. Or the computing device 400 may receive the input 440, such as queries, from a user via the user interface.

In some embodiments, the generative AI module 430 is configured to train an embedding model for code and text and use the trained embedding model in retrieval augmented generation as described herein. The generative AI module 430 may further include retrieval submodule 431 configured to perform retrieval based on a query, as described herein. The generative AI module 430 may further include generation submodule 432 configured to perform text and/or code generation based on a user query, system prompt, and/or retrieved document (e.g., via an LLM), as described herein. The generative AI module 430 may further include user interface submodule 433 configured to provide a user interface to a user allowing for input queries and displaying responses, as described herein. The generative AI module 430 may further include training submodule 434 configured to train models such as embedding model 204 as described herein.

Some examples of computing devices, such as computing device 400 may include non-transitory, tangible, machine readable media that include executable code that when run by one or more processors (e.g., processor 410) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

FIG. 4B is a simplified diagram illustrating the neural network structure implementing the generative AI module 430 described in FIG. 4A, according to some embodiments. In some embodiments, the generative AI module 430 and/or one or more of its submodules 431-434 may be implemented at least partially via an artificial neural network structure shown in FIG. 4B. The neural network comprises a computing system that is built on a collection of connected units or nodes, referred to as neurons (e.g., 444, 445, 446). Neurons are often connected by edges, and an adjustable weight (e.g., 451, 452) is often associated with the edge. The neurons are often aggregated into layers such that different layers may perform different transformations on the respective input and output transformed input data onto the next layer.

For example, the neural network architecture may comprise an input layer 441, one or more hidden layers 442 and an output layer 443. Each layer may comprise a plurality of neurons, and neurons between layers are interconnected according to a specific topology of the neural network topology. The input layer 441 receives the input data (e.g., 440 in FIG. 4A), such as a query. The number of nodes (neurons) in the input layer 441 may be determined by the dimensionality of the input data (e.g., the length of a vector of the query). Each node in the input layer represents a feature or attribute of the input.

The hidden layers 442 are intermediate layers between the input and output layers of a neural network. It is noted that two hidden layers 442 are shown in FIG. 4B for illustrative purpose only, and any number of hidden layers may be utilized in a neural network structure. Hidden layers 442 may extract and transform the input data through a series of weighted computations and activation functions.

For example, as discussed in FIG. 4A, the generative AI module 430 receives an input 440 of a query and transforms the input into an output 450 of an embedding of the query. To perform the transformation, each neuron receives input signals, performs a weighted sum of the inputs according to weights assigned to each connection (e.g., 451, 452), and then applies an activation function (e.g., 461, 462, etc.) associated with the respective neuron to the result. The output of the activation function is passed to the next layer of neurons or serves as the final output of the network. The activation function may be the same or different across different layers. Example activation functions include but not limited to Sigmoid, hyperbolic tangent, Rectified Linear Unit (ReLU), Leaky ReLU, Softmax, and/or the like. In this way, after a number of hidden layers, input data received at the input layer 441 is transformed into rather different values indicative data characteristics corresponding to a task that the neural network structure has been designed to perform.

The output layer 443 is the final layer of the neural network structure. It produces the network's output or prediction based on the computations performed in the preceding layers (e.g., 441, 442). The number of nodes in the output layer depends on the nature of the task being addressed. For example, in a binary classification problem, the output layer may consist of a single node representing the probability of belonging to one class. In a multi-class classification problem, the output layer may have multiple nodes, each representing the probability of belonging to a specific class.

Therefore, the generative AI module 430 and/or one or more of its submodules 431-434 may comprise the transformative neural network structure of layers of neurons, and weights and activation functions describing the non-linear transformation at each neuron. Such a neural network structure is often implemented on one or more hardware processors 410, such as a graphics processing unit (GPU). An example neural network may be a Transformer model, and/or the like.

In one embodiment, the generative AI module 430 and its submodules 431-434 may comprise one or more LLMs built upon a Transformer architecture. For example, the Transformer architecture comprises multiple layers, each consisting of self-attention and feedforward neural networks. The self-attention layer transforms a set of input tokens (such as words) into different weights assigned to each token, capturing dependencies and relationships among tokens. The feedforward layers then transform the input tokens, based on the attention weights, represents a high-dimensional embedding of the tokens, capturing various linguistic features and relationships among the tokens. The self-attention and feed-forward operations are iteratively performed through multiple layers of self-attention and feedforward layers, thereby generating an output based on the context of the input tokens. One forward pass for an input tokens to be processed through the multiple layers to generate an output in a Transformer architecture often entail hundreds of teraflops (trillions of floating-point operations) of computation.

For example, the Transformer-based architecture may process an input sequence of tokens (e.g., letters, symbols, numbers, signs, words, etc.) using its encoder-decoder architecture (for tasks such as machine translation, etc.) or just the encoder (for classification tasks) or decoder (for generation-only tasks). First, the input sequence may be tokenized and converted into embeddings, which are dense numerical representations, e.g., vectors of values. Positional encodings are added to these embeddings to provide information about the order of tokens.

The Transformer encoder, usually consisting of multiple layers, each of which may processes the input using a multi-head self-attention mechanism to capture relationships between tokens and a feed-forward network to transform the information, resulting in encoded representations of the input sequence of tokens.

For example, the multi-head self-attention mechanism at each Transformer layer within the Transformer encoder of an LLM may project input embeddings at the layer into three different embedding spaces using weight matrices, referred to as Query (Q) representing what a token wants to attend to, Key (K) representing what this token offers as information and Value (V) representing the actual information carried by the token. The Q K, V matrices contain tunable weights of a Transformer-based language model that are updated during training. Then, the attention mechanism computes attention scores between all tokens in the input sequence using the Q, Kand V matrices. The resulting attention scores are then used to generate encoded representations of the input sequence of tokens.

Similarly, the Transformer decoder may comprise a symmetric structure with the encoder, consisting of multiple layers, each of which may comprise a multi-head self-attention mechanism. The decoder may start with a special start token and use the multi-head self-attention mechanism, augmented with encoder-decoder attention to focus on relevant parts of the decoder input. The decoder may generate output tokens one by one, with each step using the previously generated tokens as part of the input and updated attention weights. Finally, the decoder may comprise a linear layer and softmax function predict probabilities for the next token in the sequence, selecting the most likely one to continue the output. This process repeats until a special end token is generated or a length limit is reached.

The generated sequence of tokens may jointly represent an output. For example, a Transformer-based LLM (such as LLM 110a-d) may receive a natural language input (such as a question) and generate a natural language output (such as an answer to the question).

In one embodiment, the generative AI module 430 and its submodules 431-434 may be implemented by hardware, software and/or a combination thereof. For example, the generative AI module 430 and its submodules 431-434 may comprise a specific neural network structure implemented and run on various hardware platforms 460, such as but not limited to CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware 460 used to implement the neural network structure is specifically configured based on factors such as the complexity of the neural network, the scale of the tasks (e.g., training time, input data scale, size of training dataset, etc.), and the desired performance.

For example, to deploy the generative AI module 430 and its submodules 431-434 and/or any other neural network models onto hardware platform 460, the neural network based modules 430 and its submodules 431-434 may be optimized for deployment by converting it to a suitable format, such as ONNX or TensorRT, to improve performance and compatibility. Next, depending on the size and workload requirements for modules 430 and its submodules 431-434, hardware types may be chosen for deployment, e.g., processing capacity, GPU memory size, and/or the like. Frameworks and drivers for the chosen hardware 460 frameworks and drivers may thus be installed, such as PyTorch, TensorFlow, or CUDA, to support the hardware platform 460. Then, weights and parameters of the generative AI module 430 and its submodules 431-434 may be loaded to the hardware 460. For large-scale deployments (e.g., with billions of weights for example), distributed computing frameworks may be used to handle model partitioning across multiple devices, e.g., hardware processors such as GPUs may be distributed on multiple devices, each handling a portion of weights of the model and therefore would undertake a portion of computational workload. In some embodiments, the generative AI module 430 and its submodules 431-434 may be deployed as a service, then they may be integrated with an API endpoint, using tools like Flask, FastAPI, or a cloud platform serverless services, and is accessible by a remote user via a network.

In another embodiment, some or all of layers 441, 442, 443 and/or neurons 442, 445, 446, and operations there between such as activations 461, 462, and/or the like, of the generative AI module 430 and its submodules 431-434 may be realized via one or more ASICs. For example, each neuron 442, 445 and 446 may be a hardware ASIC comprising a register, a microprocessor, and/or an input/output interface. For another example, operations among the neurons and layers may be implemented through an ASIC TPU. For yet another example, some operations among the neurons and layers such as a softmax operation, an activation function (such as a rectified linear unit (ReLU), sigmoid linear unit (SiLU), and/or the like) may be implemented by one or more ASICs.

For example, the generative AI module 430 may generate, by at least one ASIC (such as a TPU, etc.) performing a multiplicative and/or accumulative operation for a neural network language model, a next token based at least in prat on previously generated tokens, and in turn generate a natural language output representing the next-step action combining a sequence of generated tokens.

In one embodiment, the neural network based generative AI module 430 and one or more of its submodules 431-434 may be trained by iteratively updating the underlying parameters (e.g., weights 451, 452, etc., bias parameters and/or coefficients in the activation functions 461, 462 associated with neurons) of the neural network based on the loss described in Eq. (4). For example, during forward propagation, the training data such as input prompts are fed into the neural network. The data flows through the network's layers 441, 442, with each layer performing computations based on its weights, biases, and activation functions until the output layer 443 produces the network's output 450. In some embodiments, output layer 443 produces an intermediate output on which the network's output 450 is based.

The output generated by the output layer 443 is compared to the expected output (e.g., a “ground-truth” such as the corresponding responses) from the training data, to compute a loss function that measures the discrepancy between the predicted output and the expected output. For example, the loss function may be cross entropy, MMSE, or according to Eq. (4). Given the loss, the negative gradient of the loss function is computed with respect to each weight of each layer individually. Such negative gradient is computed one layer at a time, iteratively backward from the last layer 443 to the input layer 441 of the neural network. These gradients quantify the sensitivity of the network's output to changes in the parameters. The chain rule of calculus is applied to efficiently calculate these gradients by propagating the gradients backward from the output layer 443 to the input layer 441.

In one embodiment, the neural network based generative AI module 430 and one or more of its submodules 431-434 may be trained using policy gradient methods, also referred to as “reinforcement learning” methods. For example, instead of computing a loss based on a training output generated via a forward propagation of training data, the “policy” of the neural network model, which is a mapping from an input of the current states or observations of an environment the neural network model is operated at, to an output of action. Specifically, at each time step, a reward is allocated to an output of action generated by the neural network model. The gradients of the expected cumulative reward with respect to the neural network parameters are estimated based on the output of action, the current states of observations of the environment, and/or the like. These gradients guide the update of the policy parameters using gradient descent methods like stochastic gradient descent (SGD) or Adam. In this way, as the “policy” parameters of the neural network model may be iteratively updated while generating an output action as time progresses, the boundaries between training and inference are often less distinct compared to supervised learning—in other words, backward propagation and forward propagation may occur for both “training” and “inference” stages of the neural network mode.

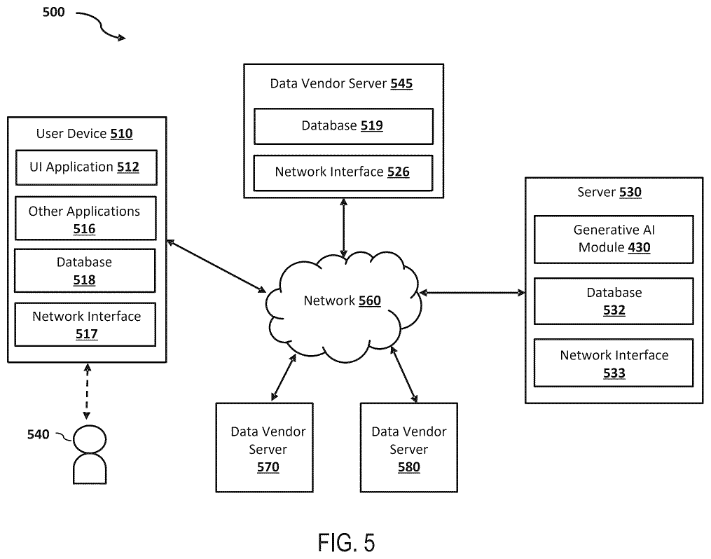

In some embodiments, generative AI module 430 and its submodules 431-434 may be housed at a centralized server (e.g., computing device 400) or one or more distributed servers. For example, one or more of generative AI module 430 and its submodules 431-434 may be housed at external server(s). The different modules may be communicatively coupled by building one or more connections through application programming interfaces (APIs) for each respective module. Additional network environment for the distributed servers hosting different modules and/or submodules may be discussed in FIG. 5.

During a backward pass, parameters of the neural network are updated backwardly from the last layer to the input layer (backpropagating) based on the computed negative gradient using an optimization algorithm to minimize the loss. The backpropagation from the last layer 443 to the input layer 441 may be conducted for a number of training samples in a number of iterative training epochs. In this way, parameters of the neural network may be gradually updated in a direction to result in a lesser or minimized loss, indicating the neural network has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as unseen prompts.

Neural network parameters may be trained over multiple stages. For example, initial training (e.g., pre-training) may be performed on one set of training data, and then an additional training stage (e.g., fine-tuning) may be performed using a different set of training data. In some embodiments, all or a portion of parameters of one or more neural-network model being used together may be frozen, such that the “frozen” parameters are not updated during that training phase. This may allow, for example, a smaller subset of the parameters to be trained without the computing cost of updating all of the parameters.

In some implementations, to improve the computational efficiency of training a neural network model, “training” a neural network model such as an LLM may sometimes be carried out by updating the input prompt, e.g., the instruction to teach an LLM how to perform a certain task. For example, while the parameters of the LLM may be frozen, a set of tunable prompt parameters and/or embeddings that are usually appended to an input to the LLM may be updated based on a training loss during a backward pass. For another example, instead of tuning any parameter during a backward pass, input prompts, instructions, or input formats may be updated to influence their output or behavior. Such prompt designs may range from simple keyword prompts to more sophisticated templates or examples tailored to specific tasks or domains.

In general, the training and/or finetuning of an LLM can be computationally extensive. For example, GPT-3 has 175 billion parameters, and a single forward pass using an input of a short sequence can involve hundreds of teraflops (trillions of floating-point operations) of computation. Training such a model requires immense computational resources, including powerful GPUs or TPUs and significant memory capacity. Additionally, during training, multiple forward and backward passes through the network are performed for each batch of data (e.g., thousands of training samples), further adding to the computational load.

In general, the training process transforms the neural network into an “updated” trained neural network with updated parameters such as weights, activation functions, and biases. The trained neural network thus improves neural network technology in AI agents, especially in the context of code generation.

FIG. 5 is a simplified block diagram of a networked system 500 suitable for implementing the generative AI framework described in FIGS. 1-4B and other embodiments described herein. In one embodiment, system 500 includes the user device 510 which may be operated by user 540, data vendor servers 545, 570 and 580, server 530, and other forms of devices, servers, and/or software components that operate to perform various methodologies in accordance with the described embodiments. Exemplary devices and servers may include device, stand-alone, and enterprise-class servers which may be similar to the computing device 400 described in FIG. 4A, operating an OS such as a MICROSOFT® OS, a UNIX® OS, a LINUX® OS, or other suitable device and/or server-based OS. It can be appreciated that the devices and/or servers illustrated in FIG. 5 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities.

The user device 510, data vendor servers 545, 570 and 580, and the server 530 may communicate with each other over a network 560. User device 510 may be utilized by a user 540 (e.g., a driver, a system admin, etc.) to access the various features available for user device 510, which may include processes and/or applications associated with the server 530 to receive an output data anomaly report.

User device 510, data vendor server 545, and the server 530 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 500, and/or accessible over network 560.

User device 510 may be implemented as a communication device that may utilize appropriate hardware and software configured for wired and/or wireless communication with data vendor server 545 and/or the server 530. For example, in one embodiment, user device 510 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLE®. Although only one communication device is shown, a plurality of communication devices may function similarly.

User device 510 of FIG. 5 contains a user interface (UI) application 512, and/or other applications 516, which may correspond to executable processes, procedures, and/or applications with associated hardware. For example, the user device 510 may receive a message indicating a response from the server 530 and display the message via the UI application 512. In other embodiments, user device 510 may include additional or different modules having specialized hardware and/or software as required.

In one embodiment, UI application 512 may communicatively and interactively generate a UI for an AI agent implemented through the generative AI module 430 (e.g., an LLM agent) at server 530. In at least one embodiment, a user operating user device 510 may enter a user utterance, e.g., via text or audio input, such as a question, uploading a document, and/or the like via the UI application 512. Such user utterance may be sent to server 530, at which generative AI module 430 may generate a response via the process described in FIGS. 1-4B. The generative AI module 430 may thus cause a display of a response/code at UI application 512 and interactively update the display in real time with the user utterance.

In various embodiments, user device 510 includes other applications 516 as may be desired in particular embodiments to provide features to user device 510. For example, other applications 516 may include security applications for implementing client-side security features, programmatic client applications for interfacing with appropriate application programming interfaces (APIs) over network 560, or other types of applications. Other applications 516 may also include communication applications, such as email, texting, voice, social networking, and IM applications that allow a user to send and receive emails, calls, texts, and other notifications through network 560. For example, the other application 516 may be an email or instant messaging application that receives a prediction result message from the server 530. Other applications 516 may include device interfaces and other display modules that may receive input and/or output information. For example, other applications 516 may contain software programs for asset management, executable by a processor, including a graphical user interface (GUI) configured to provide an interface to the user 540 to view responses.

User device 510 may further include database 518 stored in a transitory and/or non-transitory memory of user device 510, which may store various applications and data and be utilized during execution of various modules of user device 510. Database 518 may store user profile relating to the user 540, predictions previously viewed or saved by the user 540, historical data received from the server 530, and/or the like. In some embodiments, database 518 may be local to user device 510. However, in other embodiments, database 518 may be external to user device 510 and accessible by user device 510, including cloud storage systems and/or databases that are accessible over network 560.

User device 510 includes at least one network interface component 517 adapted to communicate with data vendor server 545 and/or the server 530. In various embodiments, network interface component 517 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data vendor server 545 may correspond to a server that hosts database 519 to provide training datasets including prompts to the server 530. The database 519 may be implemented by one or more relational database, distributed databases, cloud databases, and/or the like.

The data vendor server 545 includes at least one network interface component 526 adapted to communicate with user device 510 and/or the server 530. In various embodiments, network interface component 526 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. For example, in one implementation, the data vendor server 545 may send asset information from the database 519, via the network interface 526, to the server 530.

The server 530 may be housed with the generative AI module 430 and its submodules described in FIG. 4A. In some implementations, generative AI module 430 may receive data from database 519 at the data vendor server 545 via the network 560 to generate responses. The generated responses may also be sent to the user device 510 for review by the user 540 via the network 560.

In one embodiment, an AI agent implementing the generative AI module 430 and its submodules described in FIG. 4A may be built based on an LLM as described in FIG. 4B. For example, the AI agent may be configured with one or more LLMs (e.g., each pretrained for a specific task or domain), a plurality of system prompts, and connected to external APIs to databases and applications (e.g., a search engine, a cloud service, an internal database, etc.).

In some embodiments, the AI agent implementing the generative AI module 430 and its submodules described in FIG. 4A may be implemented as a cloud-based AI agent which may be accessed by user device 510 via a chatbot application, a web application, customer support or SaaS applications. In another implementation, a client-side AI agent component may be delivered from the server 530 to user device 510 for local installation such that the client-side AI agent may be installed and runs directly on the user's device. Such local AI agent on the user device 510 may be available offline to adapt to privacy-sensitive applications. In another implementation, the AI agent implementing the generative AI module 430 and its submodules described in FIG. 4A may adopt a hybrid cloud and client-based structure to balance computing speed, cost and privacy. For example, a local AI agent may handle basic AI queries locally, but complex queries may be sent to server 530 to process.

The database 532 may be stored in a transitory and/or non-transitory memory of the server 530. In one implementation, the database 532 may store data obtained from the data vendor server 545. In one implementation, the database 532 may store parameters of the generative AI module 430. In one implementation, the database 532 may store previously generated responses, and the corresponding input feature vectors.

In some embodiments, database 532 may be local to the server 530. However, in other embodiments, database 532 may be external to the server 530 and accessible by the server 530, including cloud storage systems and/or databases that are accessible over network 560.

The server 530 includes at least one network interface component 533 adapted to communicate with user device 510 and/or data vendor servers 545, 570 or 580 over network 560. In various embodiments, network interface component 533 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 560 may be implemented as a single network or a combination of multiple networks. For example, in various embodiments, network 560 may include the Internet or one or more intranets, landline networks, wireless networks, and/or other appropriate types of networks. Thus, network 560 may correspond to small scale communication networks, such as a private or local area network, or a larger scale network, such as a wide area network or the Internet, accessible by the various components of system 500.

### Example Work Flows

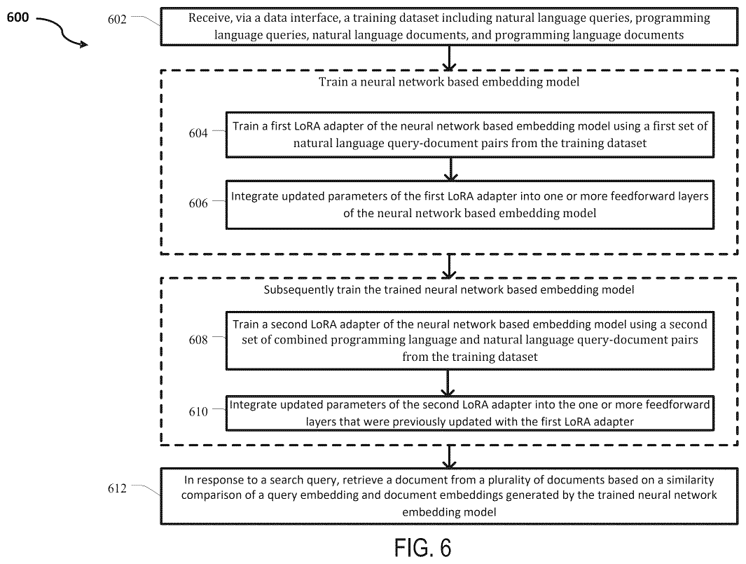

FIG. 6 is an example logic flow diagram illustrating a method 600 of unified code and natural language search based on the framework shown in FIGS. 1-5, according to some embodiments. One or more of the processes of method 600 may be implemented, at least in part, in the form of executable code stored on non-transitory, tangible, machine-readable media that when run by one or more processors may cause the one or more processors to perform one or more of the processes. In some embodiments, method 600 corresponds to the operation of the generative AI module 430 (e.g., FIGS. 4A and 5) that performs training of an embedding model and/or retrieval augmented generation utilizing the trained embedding model as described herein.

In some embodiments, method 600 is performed by a system such as computing device 400, user device 510, server 530, or another device or combination of devices. Inputs (e.g., training datasets, documents, and/or user prompts) may be received via a data interface such as data interface 415, network interface 517, network interface 533, or via a data interface that is integrated with a device. For example UI Application 512 may receive user inputs via a text input interface (e.g., keyboard), audio input (e.g., microphone), video interface (e.g., camera), or other interface for receiving user inputs (e.g., a mouse or touch display).

As illustrated, the method 600 includes a number of enumerated steps, but aspects of the method 600 may include additional steps before, after, and in between the enumerated steps. In some aspects, one or more of the enumerated steps may be omitted or performed in a different order.

At step 602, the system receives, via a data interface, a training dataset including natural language queries, programming language queries, natural language documents, and programming language documents. The training dataset may be sourced from a variety of repositories, including codebases, documentation, and question-answer pairs, and is structured to support both natural language and code retrieval tasks.

Steps 604 and 606 together are performed in order to train a neural network based embedding model (e.g.,) in a first stage.

At step 604, the system trains the neural network based embedding model by training a first LoRA adapter (e.g.,) of the neural network based embedding model using a first set of natural language query-document pairs from the training dataset. In some embodiments, training the first LoRA adapter includes using an increasing learning rate followed by an exponentially decaying learning rate, which helps the model converge efficiently and avoid overfitting. The first LoRA adapter is responsible for specializing the embedding model for natural language retrieval tasks, ensuring that the model can generate high-quality embeddings for text-based queries and documents.

At step 606, the system integrates updated parameters of the first LoRA adapter into one or more feedforward layers of the neural network based embedding model. This integration allows the model to retain the improvements learned during the first stage of training, embedding the specialized retrieval capabilities directly into the model architecture. The updated parameters enhance the model's ability to represent semantic relationships in natural language data.

Steps 608 and 620 together are performed in order to subsequently train the trained neural network based embedding model (e.g.,) in a second stage.

At step 608, the system subsequently trains the trained neural network based embedding model by training a second LoRA adapter (e.g.,) of the neural network based embedding model using a second set of combined programming language and natural language query-document pairs from the training dataset. In some embodiments, the second set of combined programming language and natural language query-document pairs includes: natural language query with natural language document; natural language query with code document; code query with natural language document; and code query with code document. In some embodiments, training the second LoRA adapter includes using a second exponentially decaying learning rate. In some embodiments, the second exponentially decaying learning rate begins at a final learning rate used during the training of the first LoRA adapter. This ensures a smooth transition between training stages and helps prevent abrupt changes in the model's parameters, maintaining stability and performance across both text and code retrieval domains. The second LoRA adapter is introduced to further adapt the model for code retrieval and hybrid tasks, building on the foundation established in the first stage.

At step 610, the system integrates updated parameters of the second LoRA adapter into the one or more feedforward layers that were previously updated with the first LoRA adapter.

At step 612, in response to a search query, the system retrieves a document from a plurality of documents based on a similarity comparison of a query embedding and document embeddings generated by the trained neural network embedding model. In some embodiments, the system may incorporate a code segment from the document in a coding environment, allowing for seamless integration of retrieved code into development workflows. In some embodiments, the system may input the document to a language model (LM) and generate an output via the LM based on the document. In some embodiments, the system may receive a partial line of code, include the partial line of code in the search query, and auto-complete the partial line of code based on the document.

In some embodiments, the system can handle various permutations of queries and responses involving both code and natural language. For example, a user might submit a natural language query such as, “What does the term ‘recursion’ mean in computer science?” and the system would respond in natural language, explaining that recursion is a method where the solution to a problem depends on solutions to smaller instances of the same problem. In another example, a user could ask in natural language, “Show me how to reverse a list in Python,” and the system would respond with the appropriate code: reversed_list=my_list[::−1]. In a different scenario, a user might provide a code snippet like for i in range(5): print(i), and the system would respond in natural language by explaining that this code prints the numbers 0 through 4, each on a new line. In yet another example, a user could input a code snippet in Java, such as for (int i=0;i<5;i++){System.out.println(i);}, and ask the system to convert it to Python. The system would then provide the equivalent Python code: for i in range(5): print(i). These examples illustrate the system's ability to flexibly process and generate both code and natural language across a variety of programming languages and query types.

In some embodiments, method 600 is applicable in a variety of applications. For example, the task request received by a neural network model (e.g., embedding model 204 and/or LLM 216) may relate to a diagnostic request in view of a medical record in a healthcare system, a curriculum designing request in an online education system, a code generation request in a software development system, a writing and/or editing request in a content generation system, an IT diagnostic request in an IT customer service support system, a navigation request in a robotic and autonomous system, and/or the like. By performing method 600, the neural network based artificial agent may improve technology in the respective technical field in healthcare and diagnostics, education and personalized learning, software development and code assistance, content creation, autonomous system (such as autonomous driving, etc.), and/or the like.

For example, when the task query includes a query to identify an information technology (IT) anomaly relating to a usage of an IT component such as a network gateway, a router, an online printer, and/or the like, by performing method 600 at an environment of a local area network (LAN), the neural network based artificial agent may receive an observation from the environment at which the next-step action is executed, and determine that the observation representing an information technology anomaly (e.g., a router failure, an unauthorized access attempt, a domain name system anomaly, and/or the like). In some implementations, the neural network based artificial agent may cause an alert relating to the information technology anomaly to be displayed at a visualized user interface, or to block traffic from an origin from where abnormal traffic has been identified. In this way, IT anomalies may be detected and alerted using the neural network based artificial agent in an efficient manner so as to improve network support technology.

In the context of software development, embodiments described herein enable developers to seamlessly search for relevant code snippets, documentation, and technical explanations using either natural language or code-based queries. This capability streamlines the process of code reuse, debugging, and onboarding, as developers can quickly locate and integrate code segments directly into their development environment. The system's ability to auto-complete partial lines of code and retrieve contextually relevant documentation further accelerates the coding process and reduces the likelihood of errors, thereby improving the overall functioning of the computer and the productivity of the user.

For information technology (IT) diagnostics and control, the system can be used to identify, retrieve, and apply troubleshooting scripts, configuration files, and technical documentation in response to user queries or detected anomalies. IT administrators can input either natural language descriptions of issues or code fragments, and the system will return the most relevant resources, including code to automate remediation steps or documentation to guide manual intervention. This reduces downtime, improves the reliability of IT infrastructure, and automates repetitive diagnostic tasks, thereby enhancing the technical capabilities of IT support systems.

### Example Results

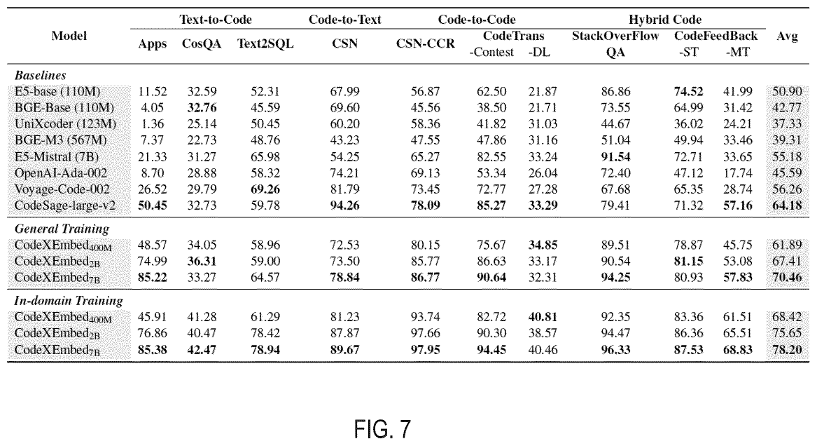

FIGS. 7-13 provide charts illustrating exemplary performance of embodiments described herein across a comprehensive suite of code and text retrieval benchmarks, as well as retrieval-augmented generation tasks. The experiments were designed to evaluate the unified retrieval capabilities of the proposed models, referred to as CODEXEMBED, against a range of strong baseline models and across multiple evaluation metrics. Baseline models used for comparison include E5-base and E5-Mistral (Wang et al., Text embeddings by weakly-supervised contrastive pre-training, arXiv:2212.03533, 2022; Wang et al., Improving text embeddings with large language models, arXiv:2401.00368, 2023), BGE-Base and BGE-M3 (Xiao et al., C-pack: Packaged resources to advance general chinese embedding, arXiv:2309.07597, 2023; Chen et al., M3-embedding: Multi-linguality, multi-functionality, multi-granularity text embeddings through self-knowledge distillation, ACL 2024), UniXcoder (Guo et al., Unixcoder: Unified cross-modal pre-training for code representation, ACL 2022), Voyage-Code-002 (Voyage AI, Voyage code 2: Elevate your code retrieval, 2024), CodeSage-large-v2 (Zhang et al., Code representation learning at scale, ICLR 2024), OpenAI-Ada-002 (Neelakantan et al., Text and code embeddings by contrastive pre-training, arXiv:2201.10005, 2022), NV-Embed-V2 (Lee et al., NV-Embed: Improved techniques for training LLMs as generalist embedding models, arXiv:2405.17428, 2024), and SFR-v2 (Meng et al., SFR-Embedding-2: Advanced text embedding with multi-stage training, 2024). The primary evaluation metrics employed were Normalized Discounted Cumulative Gain at rank 10 (NDCG@10) for both code and text retrieval, as well as Pass@1 for code generation tasks. The experiments spanned the CoIR benchmark for code retrieval (Li et al., CoIR: A comprehensive benchmark for code information retrieval models, arXiv:2407.02883, 2024), the BEIR benchmark for text retrieval (Thakur et al., BEIR: A heterogeneous benchmark for zero-shot evaluation of information retrieval models, NeurIPS Datasets and Benchmarks 2021), RepoEval for repository-level code completion (Zhang et al., Repocoder: Repository-level code completion through iterative retrieval and generation, EMNLP 2023), and SWE-bench-Lite for issue resolution (Jimenez et al., SWE-bench: Can language models resolve real-world GitHub issues?, ICLR 2024). The experimental setup also included ablation studies to assess the impact of multi-stage training, base model selection, and programming language diversity.

FIG. 7 presents the performance of the CODEXEMBED model family across various code retrieval tasks in the CoIR benchmark. The results are shown for three model sizes (400M, 2B, and 7B parameters) and are compared against baseline models including E5-base, BGE-Base, UniXcoder, BGE-M3, E5-Mistral, OpenAI-Ada-002, Voyage-Code-002, and CodeSage-large-v2. The evaluation metric used is NDCG@ 10, and the results are reported for multiple retrieval categories such as Text-to-Code, Code-to-Text, Code-to-Code, and Hybrid Code. The table demonstrates that CODEXEMBED models, particularly the 7B variant, achieve state-of-the-art results, significantly outperforming prior baselines in both general and in-domain training settings.

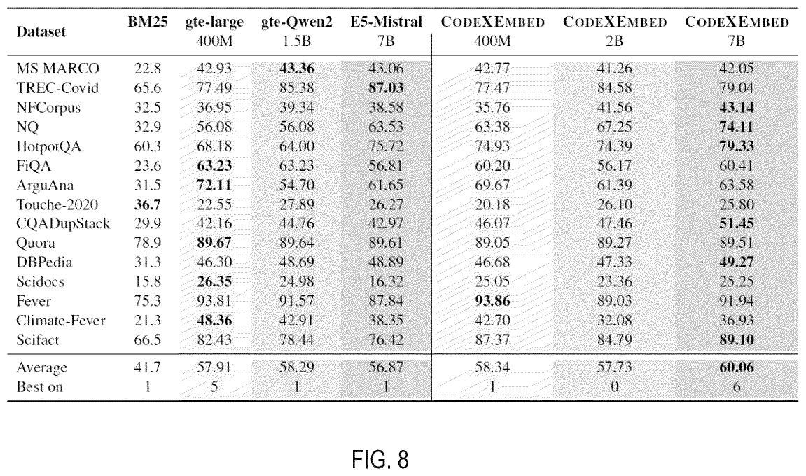

FIG. 8 compares the performance of CODEXEMBED models of different sizes (400M, 2B, 7B) on the BEIR text retrieval benchmark. The results are compared against BM25, gte-large, gte-Qwen2, E5-Mistral, and other CODEXEMBED variants. The metric used is NDCG@10, and the results are reported across 15 BEIR datasets, including MS MARCO, TREC-Covid, NFCorpus, NQ, HotpotQA, FIQA, ArguAna, Touche-2020, CQADupStack, Quora, DBPedia, Scidocs, Fever, Climate-Fever, and Scifact. The CODEXEMBED 7B model achieves an average score of over 60, placing it among the top tier on the MTEB leaderboard, and demonstrates competitive performance in text retrieval compared to leading baselines.

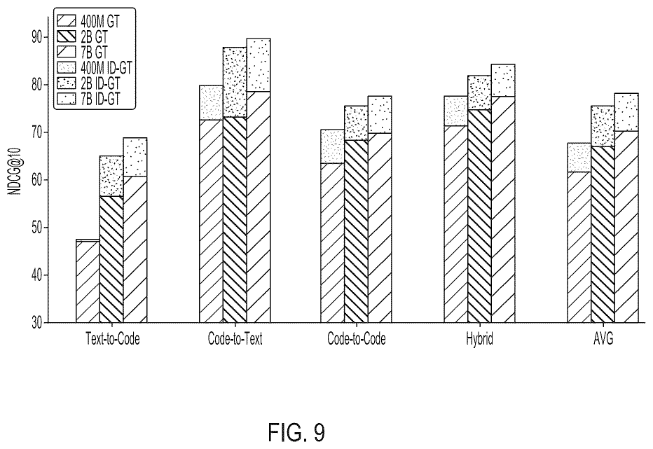

FIG. 9 visually compares the performance of CODEXEMBED models (400M, 2B, 7B) under general training (GT) and in-domain training (ID) across different CoIR categories and the overall average. The bar chart illustrates that in-domain training results in consistent performance improvements across all model sizes, with the largest gains observed in the Code-to-Text category. The 7B model, in particular, achieves the highest average performance, further validating the effectiveness of the unified training approach.

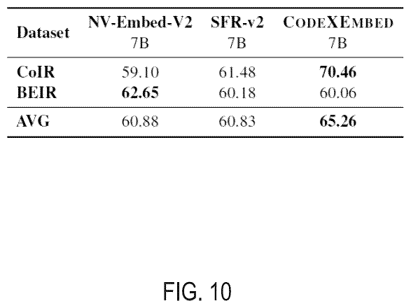

FIG. 10 presents a comparison of code and text retrieval benchmarks between CODEXEMBED 7B and the top models on the MTEB leaderboard, specifically NV-Embed-V2 and SFR-v2. The results are reported for both the CoIR and BEIR benchmarks using NDCG@10. CODEXEMBED 7B surpasses NV-Embed-V2 by 4.38 points in the average score across text and code datasets, highlighting its superior performance as a generalist embedding model.

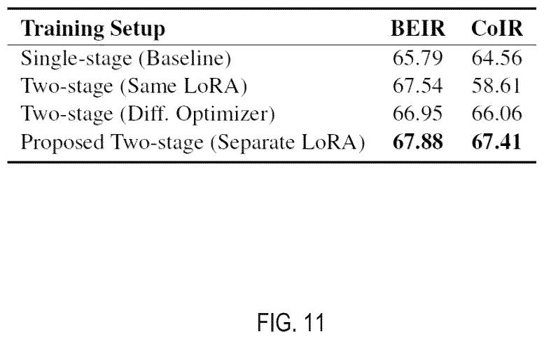

FIG. 11 reports the results of an ablation study evaluating the effectiveness of the multi-stage training approach. Four training setups are compared: Single-stage (Baseline), Two-stage (Same LoRA), Two-stage (Different Optimizers), and the Proposed Two-stage (Separate LoRA). The results, measured on BEIR dev and CoIR test sets using NDCG@10, show that the Two-stage (Separate LoRA) embodiment described herein achieves the best performance on both benchmarks, underscoring the importance of modular adaptation and continuous optimization in multi-stage training.

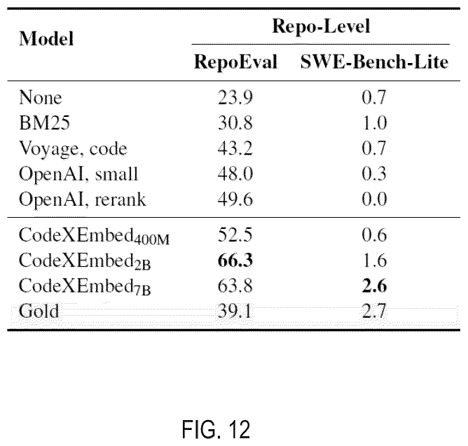

FIG. 12 illustrates the impact of different retrievers on repository-level code completion and issue resolution tasks. The results are reported for RepoEval (using Pass@1) and SWE-bench-Lite, with code generation performed by GPT-3.5-turbo using the top-5 retrieved code snippets. CODEXEMBED models of all sizes outperform canonical setups and other retrievers such as BM25, Voyage-Code-002, and OpenAI embeddings. The results indicate that improved retrieval methods significantly enhance end-to-end retrieval-augmented code generation, bringing performance closer to using gold content.

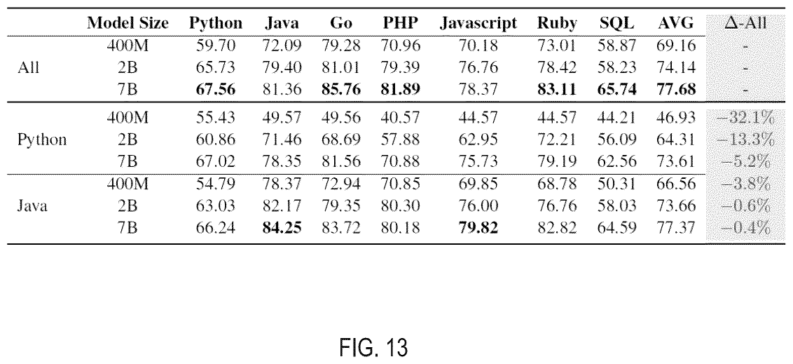

FIG. 13 illustrates the impact of programming language diversity in training on retrieval performance. The table reports NDCG@10 scores for CODEXEMBED models trained on 12 programming languages, Python-only, and Java-only subsets, across seven target languages. The results show that training with all languages yields the best average performance, while Java-only training achieves the highest scores for Java and comparable results overall. This analysis demonstrates the versatility and adaptability of the embedding model across diverse programming paradigms.

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and, in a manner, consistent with the scope of the embodiments disclosed herein.

What is claimed is:

1. A method of a unified code and natural language search system, the method comprising:
receiving, via a data interface, a training dataset including natural language queries, programming language queries, natural language documents, and programming language documents;
training a neural network based embedding model, by:
training a first LoRA adapter of the neural network based embedding model using a first set of natural language query-document pairs from the training dataset, and
integrating updated parameters of the first LoRA adapter into one or more feedforward layers of the neural network based embedding model;
subsequently training the trained neural network based embedding model by:
training a second LoRA adapter of the neural network based embedding model using a second set of combined programming language and natural language query-document pairs from the training dataset, and
integrating updated parameters of the second LoRA adapter into the one or more feedforward layers that were previously updated with the first LoRA adapter; and
in response to a search query, retrieving a document from a plurality of documents based on a similarity comparison of a query embedding and document embeddings generated by the trained neural network embedding model.

2. The method of claim 1, further comprising:
incorporating a code segment from the document in a coding environment.

3. The method of claim 2, further comprising:
inputting the document to a language model (LM); and
generating an output via the LM based on the document.

4. The method of claim 1, wherein:
the second set of combined programming language and natural language query-document pairs includes:
natural language query with natural language document;
natural language query with code document;
code query with natural language document; and
code query with code document.

5. The method of claim 1, wherein:
training the first LoRA adapter includes using an increasing learning rate followed by an exponentially decaying learning rate; and
training the second LoRA adapter includes using a second exponentially decaying learning rate.

6. The method of claim 5, wherein the second exponentially decaying learning rate begins at a final learning rate used during the training of the first LoRA adapter.

7. The method of claim 1, further comprising:
receiving a partial line of code;
including the partial line of code in the search query; and
auto-completing the partial line of code based on the document.

8. A system for unified code and natural language search, the system comprising:
a memory that stores a neural network based embedding model and a plurality of processor executable instructions;
a communication interface that receives a training dataset including natural language queries, programming language queries, natural language documents, and programming language documents; and
one or more hardware processors that read and execute the plurality of processor-executable instructions from the memory, wherein the plurality of processor-executable instructions are configurable to cause the system to perform operations comprising:
training a neural network based embedding model, by:
training a first LoRA adapter of the neural network based embedding model using a first set of natural language query-document pairs from the training dataset, and
integrating updated parameters of the first LoRA adapter into one or more feedforward layers of the neural network based embedding model;
subsequently training the trained neural network based embedding model by:
training a second LoRA adapter of the neural network based embedding model using a second set of combined programming language and natural language query-document pairs from the training dataset, and
integrating updated parameters of the second LoRA adapter into the one or more feedforward layers that were previously updated with the first LoRA adapter; and
in response to a search query, retrieving a document from a plurality of documents based on a similarity comparison of a query embedding and document embeddings generated by the trained neural network embedding model.

9. The system of claim 8, wherein the plurality of processor-executable instructions are further configurable to cause the system to perform operations comprising:
incorporating a code segment from the document in a coding environment.

10. The system of claim 9, wherein the plurality of processor-executable instructions are further configurable to cause the system to perform operations comprising:
inputting the document to a language model (LM); and
generating an output via the LM based on the document.

11. The system of claim 8, wherein:
the second set of combined programming language and natural language query-document pairs includes:
natural language query with natural language document;
natural language query with code document;
code query with natural language document; and
code query with code document.

12. The system of claim 8, wherein:
training the first LoRA adapter includes using an increasing learning rate followed by an exponentially decaying learning rate; and
training the second LoRA adapter includes using a second exponentially decaying learning rate.

13. The system of claim 12, wherein the second exponentially decaying learning rate begins at a final learning rate used during the training of the first LoRA adapter.

14. The system of claim 8, wherein the plurality of processor-executable instructions are further configurable to cause the system to perform operations comprising:
receiving a partial line of code;
including the partial line of code in the search query; and
auto-completing the partial line of code based on the document.

15. A non-transitory machine-readable medium comprising a plurality of instructions, executable by one or more processors, wherein the plurality of instructions are configurable to cause the one or more processors to perform operations comprising:
receiving, via a data interface, a training dataset including natural language queries, programming language queries, natural language documents, and programming language documents;
training a neural network based embedding model, by:
training a first LoRA adapter of the neural network based embedding model using a first set of natural language query-document pairs from the training dataset, and
integrating updated parameters of the first LoRA adapter into one or more feedforward layers of the neural network based embedding model;
subsequently training the trained neural network based embedding model by:
training a second LoRA adapter of the neural network based embedding model using a second set of combined programming language and natural language query-document pairs from the training dataset, and
integrating updated parameters of the second LoRA adapter into the one or more feedforward layers that were previously updated with the first LoRA adapter; and
in response to a search query, retrieving a document from a plurality of documents based on a similarity comparison of a query embedding and document embeddings generated by the trained neural network embedding model.

16. The non-transitory machine-readable medium of claim 15, wherein the plurality of instructions are further configurable to cause the one or more processors to perform operations comprising:
incorporating a code segment from the document in a coding environment.

17. The non-transitory machine-readable medium of claim 16, wherein the plurality of instructions are further configurable to cause the one or more processors to perform operations comprising:
inputting the document to a language model (LM); and
generating an output via the LM based on the document.

18. The non-transitory machine-readable medium of claim 15, wherein:
the second set of combined programming language and natural language query-document pairs includes:
natural language query with natural language document;
natural language query with code document;
code query with natural language document; and
code query with code document.

19. The non-transitory machine-readable medium of claim 15, wherein:
training the first LoRA adapter includes using an increasing learning rate followed by an exponentially decaying learning rate; and
training the second LoRA adapter includes using a second exponentially decaying learning rate.

20. The non-transitory machine-readable medium of claim 19, wherein the second exponentially decaying learning rate begins at a final learning rate used during the training of the first LoRA adapter.
